(19) United States
(12) Patent Application Publication
(10) Pub. No.: US 2012/0019075 A1
(43) Pub. Date: Jan. 26, 2012

(54) WIRELESS ENERGY TRANSFER APPARATUS AND METHOD FOR MANUFACTURING THE SAME

(75) Inventors: In-Kui CHO, Daejeon (KR); Je-Hoon YUN, Daejeon (KR); Jung-Ick MOON, Daejeon (KR); Seong-Min KIM, Daejeon (KR)

(73) Assignee: ELECTRONICS AND TELECOMMUNICATIONS RESEARCH INSTITUTE, Daejeon (KR)

(21) Appl. No.: 13/186,650

(22) Filed: Jul. 20, 2011

(30) Foreign Application Priority Data
Jul. 23, 2010 (KR) 10-2010-0071249

(51) Int. Cl. H02J 17/00; H01F 7/06

(52) U.S. Cl. 307/104; 29/605

(57) ABSTRACT

A wireless power transfer apparatus includes: a transmitting coil into which a current having a predetermined frequency is introduced; a receiving coil configured to supply a current induced by electromagnetic induction to a load; and a transmission-side resonant coil and a reception-side resonant coil positioned between the transmitting coil and the receiving coil, configured to provide the current flowing in the transmitting coil to the receiving coil through electromagnetic induction, and spaced a predetermined distance from each other. Each of the resonant coils has a spiral structure.

### CROSS-REFERENCE TO RELATED APPLICATIONS

The present application claims priority of Korean Patent Application No. 10-2010-0071249, filed on Jul. 23, 2010, which is incorporated herein by reference in its entirety.

### BACKGROUND OF THE INVENTION

1. Field of the Invention

Exemplary embodiments of the present invention relate to a wireless power transfer apparatus; and, more particularly, to a wireless power transfer apparatus using magnetic resonance, a method for manufacturing a resonant coil thereof, and a method for tuning a resonant frequency.

2. Description of Related Art

Energy is a term to express the ability that a physical system has to do work on the other physical systems, and a physical terminology of heat, electricity, power or the like. Representative examples of such energy may include electrical energy, firepower energy, hydraulic energy, thermal energy and so on. The most basic method for transferring electrical energy among the energies is to transfer the electrical energy through a conductor capable of passing an electric current.

Another method for transferring electrical energy uses an electrical field to generate power. In this method, an electromotive force induced by a magnetic field and an electric field is used to transfer power from one side to the other side through a primary coil and a secondary coil. Such a method is basically used in a power plant or the like.

Another method for transferring electric energy is to transfer a signal with constant power to the air. Although such a method is widely used in a wireless communication scheme, it is not an efficient energy transfer method.

Meanwhile, the Massachusetts Institute of Technology (MIT) has developed a new power transfer method in 2007. In the new method for wirelessly transferring energy, two magnetic resonant bodies having the same frequency are used to transfer wireless energy through mutual resonance by mainly using magnetic field resonance, different from an existing method using antennas. In the method published by MIT, a resonant body has a helical structure, a resonant frequency is 10 MHz, and the structural helical size of the resonant body is set in such a manner that a diameter is 600 mm, a turn number is 5.25, a line thickness is 6 mm, the entire thickness of the helical structure is 200 mm, and a single feeding loop of a signal is 250 mm.

In the method developed by MIT, however, the size and the resonant frequency have values which are not suitable for applying to real products. That is, the resonant body for wireless power transfer has a too large size, and the resonant frequency corresponds to a frequency which may have an effect upon the human body. In order to perform wireless power transfer in a real product, a resonant frequency of 10 MHz or less may be used. However, the size of the resonant structure is a function of the resonant frequency. Therefore, when the resonant frequency is lowered to less than the resonant frequency of the method developed by MIT, the size of the resonant structure inevitably increases.

### SUMMARY OF THE INVENTION

An embodiment of the present invention is directed to a wireless power transfer apparatus capable of reducing the resonant frequency and size of a resonant body.

Another embodiment of the present invention is directed to a method for manufacturing a resonant coil forming a wireless power transfer apparatus capable of reducing the resonant frequency and size of a resonant body.

Another embodiment of the present invention is directed to a method for tuning a resonant frequency of a resonant body.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a wireless power transfer apparatus includes: a transmitting coil into which a current having a predetermined frequency is introduced; a receiving coil configured to supply a current induced by electromagnetic induction to a load; and a transmission-side resonant coil and a reception-side resonant coil positioned between the transmitting coil and the receiving coil, configured to provide the current flowing in the transmitting coil to the receiving coil through electromagnetic induction, and spaced a predetermined distance from each other. Each of the resonant coils has a spiral structure.

In accordance with another embodiment of the present invention, a method for manufacturing a resonant coil forming a wireless power transfer apparatus includes: winding a conducting plate having a predetermined line width and line thickness in a spiral shape; stacking two or more spiral layers in a helical shape such that each of the spiral layers is wound in the opposite direction of the winding direction of another spiral layer which is directly contacted; and coupling the respective spiral layers through a conducting plate such that magnetic fields generated by the currents induced between the spiral layers complement each other.

In accordance with another embodiment of the present invention, a method for tuning a resonant frequency in a resonant coil forming a wireless power transfer apparatus includes: a plurality of spiral layers constructed by winding conducting plates having a predetermined line width and line thickness in a spiral shape and stacked in a helical shape such that the winding direction of each of the spiral layers is set in the opposite direction of the winding direction of another spiral layer which is directly contacted; and a conducting plate coupling the spiral layers such that magnetic fields generated by currents induced between the spiral layers complement each other. At least one of the spiral layers is moved by a distance corresponding to a predetermined resonant frequency in a one-axis direction.

In accordance with another embodiment of the present invention, a method for tuning a resonant frequency in a resonant coil forming a wireless power transfer apparatus includes: a plurality of spiral layers constructed by winding conducting plates having a predetermined line width and line thickness in a spiral shape and stacked in a helical shape such that the winding direction of each of the spiral layers is set in the opposite direction of the winding direction of another spiral layer which is directly contacted; and a conducting plate coupling the spiral layers such that magnetic fields generated by currents induced between the spiral layers complement each other. The conducting plate has a line width corresponding to a predetermined resonant frequency.

In accordance with another embodiment of the present invention, a method for tuning a resonant frequency in a resonant coil forming a wireless power transfer apparatus includes: a plurality of spiral layers constructed by winding conducting plates having a predetermined line width and line thickness in a spiral shape and stacked in a helical shape such that the winding direction of each of the spiral layers is set in the opposite direction of the winding direction of another spiral layer which is directly contacted; and a conducting plate coupling the spiral layers such that magnetic fields generated by currents induced between the spiral layers complement each other. A predetermined dielectric material is inserted between the spiral layers and between the conducting plates forming the spiral layers, and a distance between the conducting plates which form the spiral layers and between which the dielectric material is inserted is controlled to a distance corresponding to a predetermined resonant frequency.

### BRIEF DESCRIPTION OF THE DRAWINGS

FIGS. 1A and 1B are diagrams showing simulation results of a magnetic field (H-field) and an electric field (E-field) of a magnetic resonance apparatus having a helical structure related to the present invention.

FIG. 2 illustrates a basic structure of a wireless power transfer apparatus developed by MIT, which was published in Science (2007).

FIGS. 3A to 3D illustrate a variety of attempts to construct resonant coils in accordance with an embodiment of the present invention.

FIG. 4 is a configuration diagram of a resonance apparatus using magnetic resonance in accordance with another embodiment of the present invention.

FIG. 5 is a diagram illustrating a resonant body having a helical structure using spiral layers and transmitting/receiving coils in accordance with the embodiment of the present invention.

FIG. 6 illustrates a case in the resonant coil and the transmitting or receiving coil in accordance with the embodiment of the present invention are seen from the top.

FIG. 7 shows a simulation graph when the dielectric distance is changed in the resonant body in accordance with the embodiment of the present invention.

FIGS. 8A to 8C are diagrams explaining a method for connecting a resonant coil having a spiral structure in accordance with the embodiment of the present invention.

FIGS. 9A to 9D are simulation graphs for explaining a method for tuning the resonant frequency of the resonator manufactured in accordance with the embodiment of the present invention.

FIG. 10 shows simulation results based on changes in resonant frequency when a dielectric material is inserted into the entire resonant body and when a part of the dielectric material is removed.

FIG. 11 is a diagram for explaining changes in resonant frequency while the structure of the resonant body is modified in various manners.

FIGS. 12A to 12C illustrate the structure of a resonator having two rectangular spiral layers in accordance with another embodiment of the present invention.

### DESCRIPTION OF SPECIFIC EMBODIMENTS

Exemplary embodiments of the present invention provide a resonant structure, and the material, structure, and manufacturing method thereof will be described.

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Furthermore, the embodiments of the present invention relate to the structure of a resonant element for wireless power transfer using magnetic resonance, and specifically, to an apparatus and method for miniaturization. For this structure, the resonant element in accordance with the embodiments of the present invention has a structure for miniaturization through a combination of an existing helical structure and a spiral structure. Therefore, the resonant body may achieve miniaturization which is necessary to apply the resonant body to a variety of devices. Furthermore, the embodiments of the present invention provide a method for tuning the resonant frequency of the resonant structure, and methods for facilitating the manufacturing process of a magnetic resonance apparatus will be described.

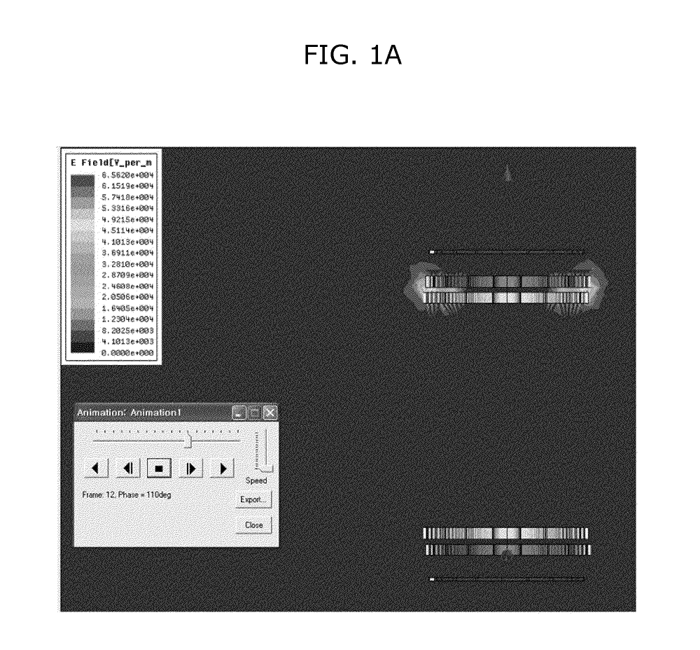

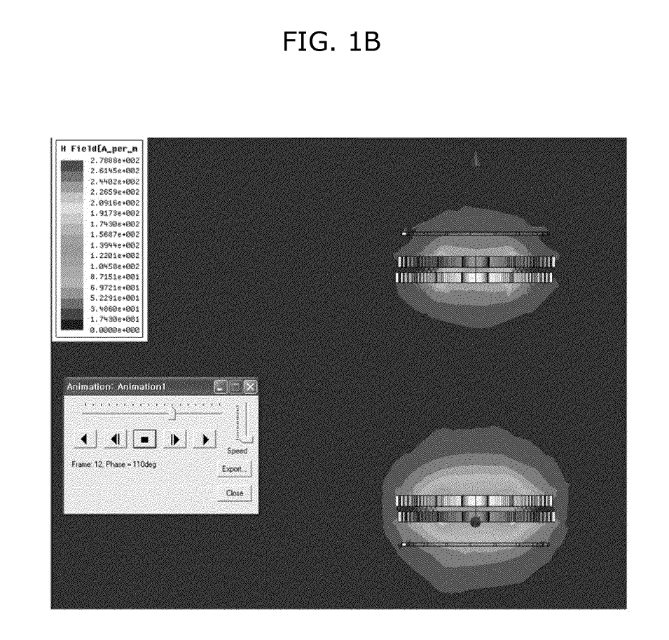

FIGS. 1A and 1B are diagrams showing simulation results of a magnetic field (H-field) and an electric field (E-field) of a magnetic resonance apparatus having a helical structure related to the present invention.

FIG. 1A shows a simulation result of the E-field, and FIG. 1B shows a simulation result of the H-field. Referring to the simulation results of the E-field and the H-field as shown in FIGS. 1A and 1B, it can be seen that the above-described helical structure has an interesting characteristic.

The interesting characteristic of the simulation results may be recognized by observing the intensity of the field around a magnetic resonance element based on a phase. That is, it can be seen that the magnitudes of the E-field and the H-field are alternated. This will be described below in detail using Table 1.

TABLE 1

| | E_mag | E_mag | | H_mag | H_mag |
|---|---|---|---|---|---|
| | mini- | maxi- | | mini- | maxi- |
| | mum | mum | | mum | mum |
| E-Field | Phase | Phase | H-Field | Phase | Phase |
| Transmitter | 100° | 10° | Transmitter | 0°-10° | 100° |
| resonator | | | resonator | | |
| Receiver | 0°-10° | 90°-100° | Receiver | 100° | 0°-10° |
| resonator | | | resonator | | |

In Table 1, a transmission-side coil is referred to as a transmitter resonator, a reception-side coil is referred to as a receiver resonator, and the magnitudes of the E-field and the H-field around the transmitter resonator and the receiver resonator were compared and recorded.

As known from Table 1, when the E-field of the transmitter resonator is minimum, the H-field of the receiver becomes maximum, and when the E-field of the transmitter resonator is maximum, the H-field of the receiver becomes maximum. When resonance occurs, energy is transmitted without an energy loss. Therefore, when the E-field of the transmitter resonator is maximum, the H-field of the receiver resonator becomes maximum.

When power of 1 W is to be transmitted, the maximum magnitudes of the E-field and the H-field in the center of the transmitter/receiver resonators were checked as follows. The E-field in the center of the transmitter/receiver resonators was 47V/m, and the H-field in the center of the transmitter/receiver resonators was 0.817 A/m.

Through the result, it can be seen that the magnitude of the H-field is about six-seven times larger than in a general plane wave. Furthermore, when the resonant structure having a helical shape is seen from the viewpoint of an equivalent circuit, the resonant structure may be considered as a combination of inductance (L) and capacitance (C). Therefore, the resonant frequency of the resonant structure having a helical structure is decided by the inductance and the capacitance.

In the case of a general helical structure, inductance components form a majority, and the resonant frequency is decided by the diameter and turn number of a coil thereof. Simply speaking, in order to lower the resonant frequency or reduce the size of the resonant structure, it is important to increase the inductance value.

Furthermore, since the final resonant frequency is decided by a parasitic capacitance value, it is necessary to find a structure which increases the capacitance value.

In a general structure, however, when the capacitance value is increased, the inductance value relatively decreases, and when the inductance value is increased, the capacitance value decreases, which means that it is very difficult to simultaneously increase the inductance value and the capacitance value. Therefore, it is very important to find a structure capable of deriving an optimal inductance value and an optical capacitance value.

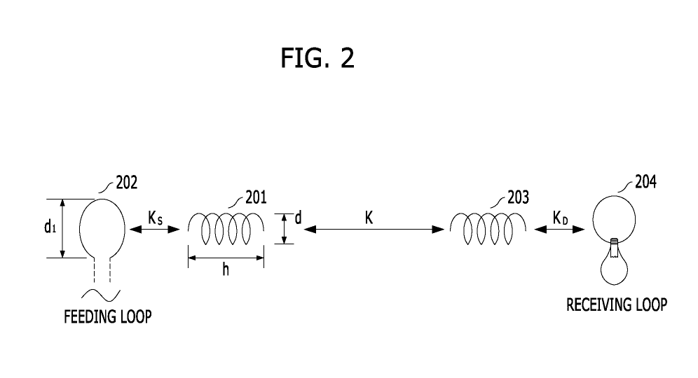

FIG. 2 illustrates a basic structure of a wireless power transfer apparatus developed by MIT, which was published in Science (2007).

Referring to FIG. 2, the wireless power transfer apparatus includes a helical coil 201 and a feeding loop 202 for transmission impedance matching in a transmission side. Furthermore, the wireless power transfer apparatus has a reception-side structure corresponding to the transmission-side structure. That is, the wireless power transfer apparatus includes a helical coil 203 and a receiving loop 204 in the reception side.

MIT has manufactured the helical coil 201 having the structure illustrated in FIG. 2 under the following condition.

The diameter a of a coil forming the helical coil 201 was set to 3 mm, the diameter d of the helical coil 201 was set to 60 cm, the turn number n of the helical coil 201 was set to 5.25, and the thickness of the entire coil, that is, the height h of the helical shape was set to 20 cm. Furthermore, the feeding loop 202 and the receiving loop 204 were manufactured in such a manner as to have a diameter d₁ of 50 cm which is slightly smaller than the diameters of the helical coils 201 and 203.

In such a case, the resonant frequency between the helical coils 201 and 203 is 10.0560.3 MHz. Furthermore, the feeding loop 202 and the transmission-side helical coil 201 are spaced from each other by K_{S}, and the reception-side helical coil 203 and the receiving loop 204 are spaced from each other by K_{D}. Furthermore, a light bulb is installed in the receiving loop 204, in order to check that power is wirelessly transferred.

The operation of the above-described structure may be described briefly as follows. When a signal source having the resonant frequency is inputted to the feeding loop 202, a current is induced in the transmission-side helical coil 201, and resonance occurs between the reception-side helical coil 203 and the transmission-side helical coil 201 which are spaced from each other by a distance K. Accordingly, the electromagnetic induction generates a current in the reception-side helical coil 203. As such, the current generated by the resonance in the reception-side helical coil 203 is induced in the receiving loop 204. Through the operation, the light bulb installed in the receiving loop 204 emits light.

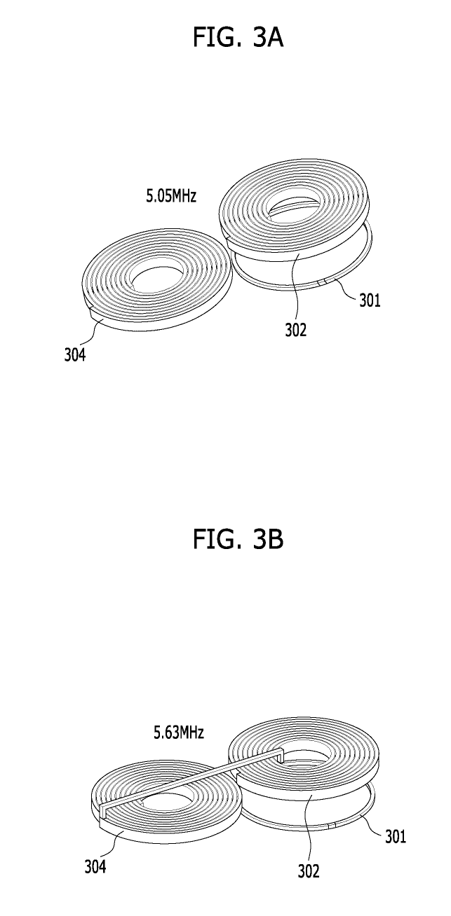

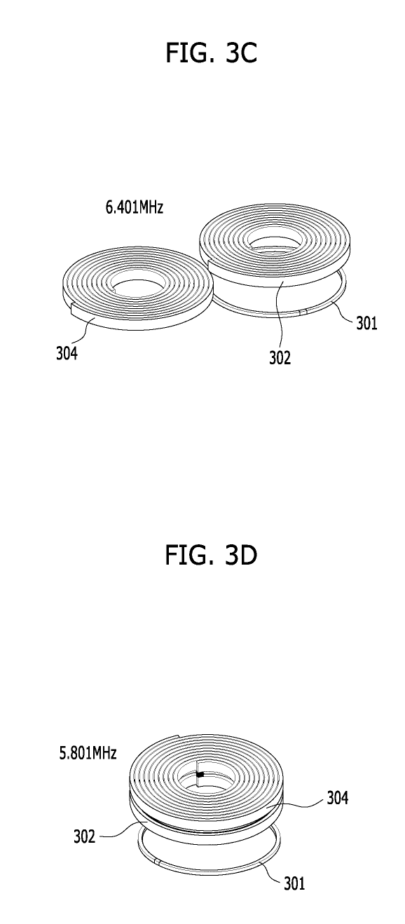

FIGS. 3A to 3D illustrate a variety of attempts to construct resonant coils in accordance with an embodiment of the present invention. In the following descriptions, the variety of attempts are made to help an understanding of the present invention.

Furthermore, a transmission-side resonant coil will be used together with a term of “transmission-side resonant body”, and a reception-side resonant coil will be used together with a term of “reception-side resonant body”. In addition, when the transmission side and the reception side are not discriminated, “resonant body” and “resonant coil” will be used together.

FIGS. 3A to 3D illustrate resonant bodies having a spiral structure which are proposed in accordance with the embodiment of the present invention.

The four different structures illustrated in FIGS. 3A to 3D are not constructed of simple coaxial lines, but are constructed by winding a plate structure having a constant width w₁ and thickness t in a spiral form. Between the coaxial plate and the coaxial plate, a dielectric material having a relative permittivity of about 10 is used. At this time, it is assumed that a spiral diameter is set to 15 cm, the turn number is set to a, a line width is set to w₁, the thickness of the dielectric material is set to 1 mm, and the thickness of a conducting plate is set to 3 mm.

FIGS. 3A to 3C are diagrams for explaining changes in resonant frequency when different spiral layers 302 and 304 are arranged in an array form. FIG. 3D is a diagram for explaining changes in resonant frequency when different spiral layers 302 and 304 are connected in a stack structure. In FIG. 3D, the upper and lower layers have the same arrangement.

“Spiral layer” will be described in more detail when the configuration in accordance with the embodiment of the present invention is described, and thus the descriptions thereof are omitted herein. The spiral layers 302 and 304 are arranged in a line parallel to the x-y plane in FIGS. 3A to 3C. In FIG. 3A, internal lines of the coils 302 and 304 having a spiral structure are connected to each other. In FIG. 3B, an internal line and an external line of the coils 302 and 304 having a spiral structure are connected to each other. In FIG. 3C, external lines of the coils 302 and 304 having a spiral structure are connected to each other. In FIGS. 3A to 3D, a transmitting/receiving coil 301 required for feeding power to the resonant body or inducing a current is illustrated together.

FIG. 3D illustrates a structure in which spiral layers 302 and 304 wound in the same manner are stacked to have a helical shape as a whole. In FIG. 3D, a transmitting/receiving coil 301 is also illustrated together.

FIGS. 3A to 3D also provide resonant frequencies when the respective structure have two spiral layers. That is, when the spiral layers are constructed according to the above-described conditions, the respective structures of FIGS. 3A to 3D have different resonant frequencies. Furthermore, it can be seen that the structures of FIGS. 3A to 3D have lower resonant frequencies than the structure proposed by MIT. However, although the four cases of FIGS. 3A to 3D are used to check the resonant frequencies through the experiment, it is still not enough to acquire an inductance value (L) and a capacitance value (C) for an optimal resonant frequency.

Now, simulations of changes in resonant frequency based on the turn number and the line width in the above-described structures will be described with reference to Tables 2 and 3.

TABLE 2

| | [symbol] | [symbol] | [symbol] | [symbol] | [symbol] | [symbol] | [symbol] | [symbol] | [symbol] | [symbol] |
|---|---|---|---|---|---|---|---|---|---|---|
| 1 | 1.051E+009 | 1.026E+007 | 8.124E+006 | 7.419E+006 | 7.180E+006 | 7.159E+006 | 7.178E+006 | 7.296E+006 | 7.455E+006 | 7.589E+006 |

[symbol]

indicates data missing or illegible when filed

TABLE 3

| | w1 = ‘3 mm’ | w1 = ‘5 mm’ | w1 = ‘7 mm’ | w1 = ‘9 mm’ | w1 = ‘10 mm’ | w1 = ‘11 mm’ |
|---|---|---|---|---|---|---|
| 1 | 5017713.1 . . . | 4716985.1 . . . | 4437309.1 . . . | 4107566.2 . . . | 2317070.6 . . . | 2209621.0 . . . |

Referring to Table 2, the resonant frequency characteristic based on the turn number will be described. As described above, the turn number was set to a, and the line width was set to w. Therefore, in Table 2, it can be seen that only the turn number is changed. As the turn number a increases, the inductance value increases, and thus the resonant frequency gradually decreases. However, it can be seen that when the turn number a becomes 10 or more, the resonant frequency starts to increase. This is because, when the turn number increases to a constant value or more, the capacitance value decreases. Therefore, the turn number may be set to such a proper value as to acquire a desired resonant frequency, without continuously increasing the turn number.

Referring to Table 3, the resonant frequency changes based on the line width w will be described. In Table 3, the turn number is fixed to 10 which is the most proper turn number as described above, and only the line width w is changed. In Table 3, it can be seen that an increase of the line width w reduces the resonant frequency, until the line width w reaches a predetermined value. That is, when the line width w increases to the predetermined value or more, the increase of the line width also starts to increase the resonant frequency. Furthermore, the reduction in resonant frequency caused by the increase of the line width is not so large.

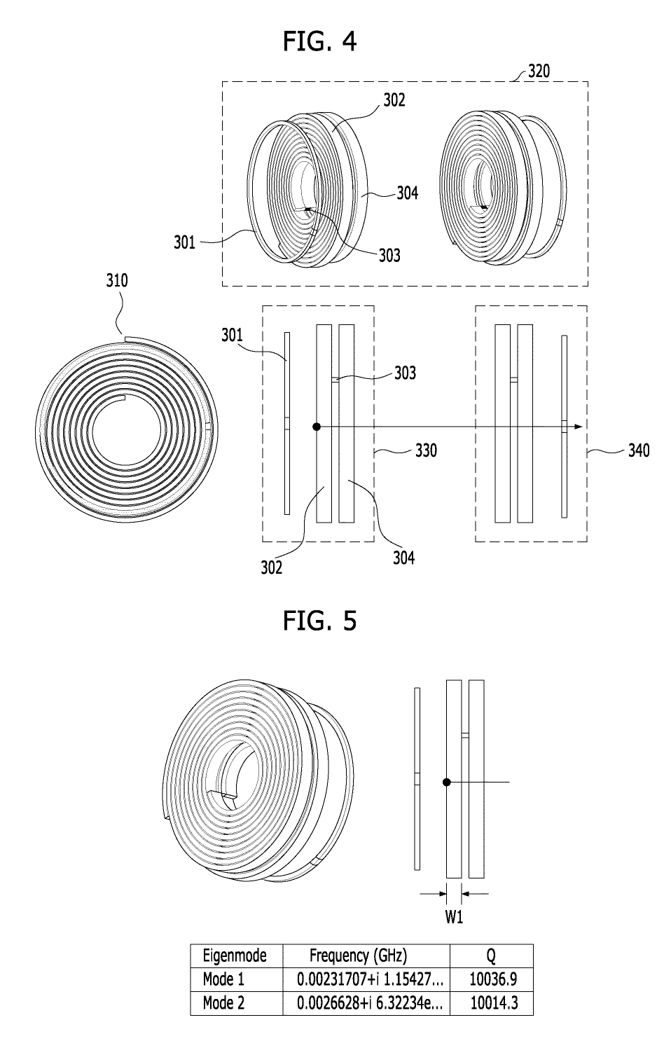

FIG. 4 is a configuration diagram of a resonance apparatus using magnetic resonance in accordance with another embodiment of the present invention.

First, the configuration of FIG. 4 will be described. In FIG. 4, the same reference numerals as those of FIG. 3 are used.

Referring to FIG. 4, the resonant body in accordance with the embodiment of the present invention includes one or two or more spiral layers 302. FIG. 4 illustrates a case in which two or more spiral layers 302 and 304 are combined and constructed in a helical shape. Hereinafter, although the resonant body may include one or two or more spiral layers, the following descriptions will be focused on a case in which only two spiral layers are provided, for convenience for explanation.

First, the spiral layer in accordance with the embodiment of the present invention will be described. The spiral layer forming the resonant body in accordance with the embodiment of the present invention has an empty space formed therein and is constructed by winding a coil in one layer, as indicated by reference numeral 310. The spiral structure obtained by winding a coil in one layer has a thickness corresponding to a line width of the coil. When two different spiral layers are stacked in a cylindrical shape, the helical shape is obtained.

At this time, the coils forming the two different spiral layers, respectively, are wound in the opposite directions. That is, when the coil of a first spiral layer is wound in the clockwise direction, the coil of a second spiral layer may be wound in the counterclockwise direction. The coils wound in different directions may be checked as indicated by reference numeral 320. That is, referring to reference numeral 303 within the reference numeral 320, it can be seen that the coils of the two spiral layers are wound in the opposite directions.

Furthermore, the two different spiral layers are spaced a predetermined distance from each other, and the start points of the coils in the respective spiral layers are coupled to each other through a conducting plate 303. As described above, the two different spiral layers are stacked in a cylindrical shape, thereby forming a helical shape.

The helical structure obtained by staking the above-described spiral layers becomes a resonant body or resonant coil. Therefore, a feeding loop 301 for feeding power is included at a position spaced a predetermined distance. The feeding loop 301 should be impedance-matched. The feeding loop 301 has input impedance which is decided by a function of the diameter of the loop and a distance from a device in which spiral layers forming a transmission-side resonator are stacked in a helical shape. Therefore, the input impedance of the feeding loop 301 is matched to 500 hm. Such a phenomenon corresponds to a characteristic of a transformer.

As described above, the resonant body may include one spiral layer or two or more spiral layers. Such spiral layers may be manufactured in a substrate structure. In general, energy may be transferred up to a distance corresponding to the double of the diameter of the spiral layer.

When the above-described resonant body is assumed to be a transmission-side resonant body, a reception-side resonant body has the same shape as the transmission-side resonant body and is positioned so as to be spaced a predetermined distance. Through the above-described process, the wireless power transfer apparatus in accordance with the embodiment of the present invention is constructed. In the above-described structure, the transmission-side resonant body feeds power, and the reception-side resonant body induces power at a resonant frequency. For example, when it is assumed that the left side of FIG. 4 is the transmission-side resonant coil 330, the right side becomes the reception-side resonant coil 340.

As described above, the resonance structure of the components forming one side of the resonator for wireless power transfer in accordance with the embodiment of the present invention has a structural characteristic in which the spiral structure is combined with a helical structure. Due to such a structural characteristic, the resonance structure has a method of simultaneously increasing an inductance value and a capacitance value, as described with reference to FIG. 1.

First, the resonant frequency may be expressed as Equation 1 below.

$${f}_{0} = \frac{1}{2 π \sqrt{LC}} \qquad Eq . 1$$

Furthermore, when two conductors are arranged in parallel, the capacitance value between the conductors may be expressed as Equation 2 below.

$$C ∝ \frac{{ɛ}_{r}}{ln ( d / a )} \qquad Eq . 2$$

In Equation 2, it can be seen that a permittivity for deciding a numerator is required to acquire a sufficient capacitance value. Therefore, it is advantageous to insert a dielectric material. When the dielectric material is inserted, the resonant frequency may be lowered by \sqrt{εᵣ} times the relative permittivity, as known from Equation 1.

For example, when it is assumed that the relative permittivity is 9, a dielectric material is not used, and thus the resonant frequency may be reduced to a value three times smaller than that of a structure having a permittivity of 1. At this time, the dielectric material may be positioned between two metal plates. Furthermore, as known from Equation 2, it is advantageous to reduce the distance between the two conductors and to increase the thickness of the conductors. On the other hand, in order to increase the inductance value, the turn number and the cross-sectional area of the coil may be increased, and the thickness h of the conductors may be reduced.

Furthermore, the inductance value of the spiral structure is larger than that of the helical structure having the same size. For example, while the MIT helical structure described with reference to FIG. 2 has an inductance value of 20 uH, the spiral structure having the same diameter has an inductance value of about 40 uH, which means that the spiral structure has an advantage in miniaturization and planarization. Therefore, the spiral structure may be manufactured in a substrate structure.

FIG. 5 is a diagram illustrating a resonant body having a helical structure using spiral layers and transmitting/receiving coils in accordance with the embodiment of the present invention.

Referring to FIG. 5, the resonant body having a helical structure using spiral layers is not constructed of simple coaxial lines, but forms a spiral structure to have a plate structure with a constant width w₁ and thickness t. At this time, a dielectric material having a relative permittivity of about 10 is inserted between the coaxial lines of the spiral structure having a plate structure and between the spiral layers.

A simulation result displayed in the lower side of FIG. 5 will be described briefly.

In the simulation result of FIG. 5, Mode 1 and Mode 2 represent a resonance mode. In general, when a certain structure is provided, a resonant frequency is decided by a resonant structure. In FIG. 5, Mode 1 and Mode 2 mean such a resonant frequency. That is, Mode 1 means a first resonant frequency, and Mode 2 means a second resonant frequency. In FIG. 5, the resonant frequencies Mode 1 and Mode 2 are 2.3 MHz and 12.6 MHz. Furthermore, the simulation result shows a selectivity Q at each resonant frequency.

Hereinafter, the background in which the helical structure using spiral layers was selected as one of the methods in accordance with the embodiment of the present invention will be described.

First, a coaxial line forming a spiral layer in the embodiment of the present invention has a specific line width, and thus may be referred to as a coaxial plate. Then, a result obtained by simulating changes in resonant frequency based on the line width of the coaxial plate used as a coil in the embodiment of the present invention will be described with reference to Table 4.

TABLE 4

| W₁ [mm] | 3 | 5 | 7 | 9 | 10 | 11 | 15 | 20 |
|---|---|---|---|---|---|---|---|---|
| Resonance | 5.02 | 4.72 | 4.44 | 4.11 | 2.32 | 2.21 | 2.43 | 2.46 |
| mode [MHz] | | | | | | | | |

The simulation of the changes in resonant frequency based on the line width was performed under the following conditions.

First, the spiral diameter was set to 15 cm, and the turn number was set to 10. The line width w₁ of the coaxial plate used as a coil in the simulation was changed. Through the simulation result of Table 4, it can be seen that the resonant frequency decreases while the line width w₁ is changed from 3 mm to 11 mm.

Here, as the width continuously increases, the resonant frequency starts to increase after a specific line width w₁. In other words, the resonant frequency decreases in proportional to the line width, until the line width reaches the specific value. In such a relationship, when the line width is doubled, the resonant frequency is reduced ½ times.

In a general substrate structure, when a line width is doubled, a resonant frequency is reduced 1/\sqrt{2} times, which means that the increase of the line width in the structure in accordance with the embodiment of the present invention is considerably advantageous in miniaturization.

This will be described in more detail with reference to Table 4. As the line width w₁ is increased from 3 mm to 9 mm, the reduction of the resonant frequency has the following characteristic: the increase of the line width w₁ reduces the inductance value rather than increases the capacitance value. However, as shown in Table 4, it can be seen that the resonant frequency rapidly decreases at a specific line width of 10 mm.

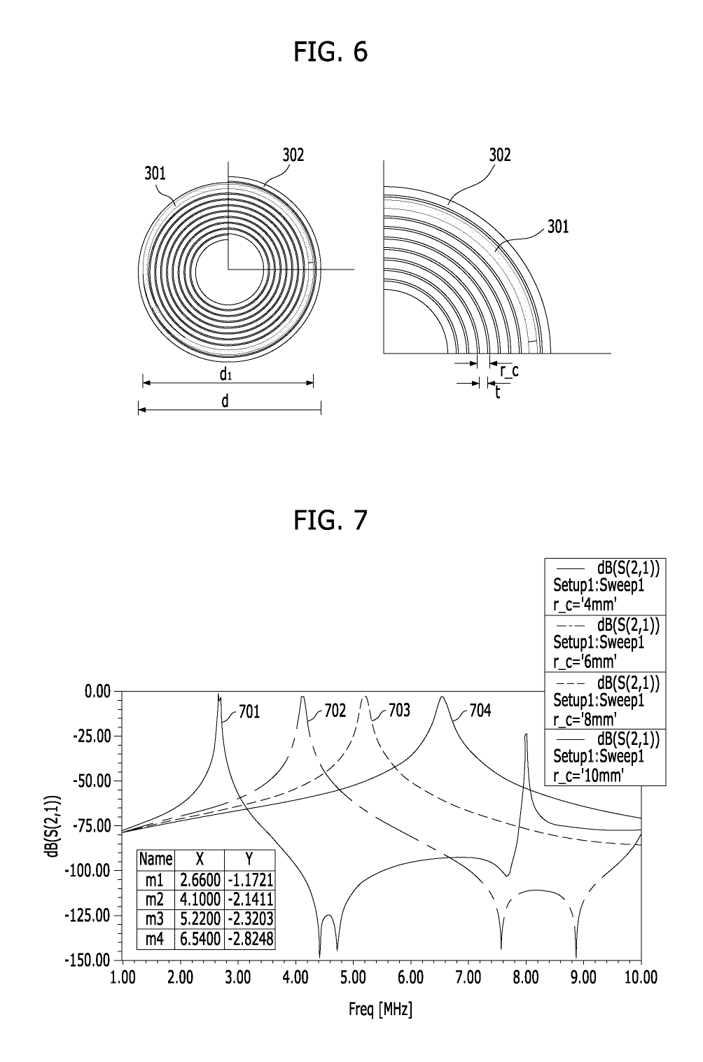

FIG. 6 illustrates a case in the resonant coil and the transmitting or receiving coil in accordance with the embodiment of the present invention are seen from the top.

Referring to FIG. 6, the relation between the resonant frequency and the dielectric distance between conducting plates in a state in which the resonant coil and the transmitting or receiving coil in accordance with the embodiment of the present invention has the same line width will be described.

First, the shape of the coil illustrated in FIG. 6 will be described. FIG. 6 illustrates the feeding loop 301 for performing power feeding in the left side, in order to compare the diameter of the spiral layer 302 having a plate shape. Referring to FIG. 6, it can be seen that the diameter d₁ of the feeding loop 301 is smaller than the diameter d of the spiral layer 302 having a plate shape.

When it is assumed that the thickness t of the conducting plate is fixed to 3 mm and the line width of the spiral layer is constant, the dielectric distance between the conducting plates may be obtained by subtracting the thickness t of the conducting plate from a distance r_c between the conducting plates. The dielectric distance may be expressed as Equation 3 below.

Dielectric distance=r_{c}−t Eq. 3

FIG. 7 shows a simulation graph when the dielectric distance is changed according to the relation based on Equation 3.

In FIG. 7, reference numeral 701 indicates a graph when the distance r_c between the conducting plates is set to 4 mm, reference numeral 702 indicates a graph when the distance between r_c the conducting plates is set to 6 mm, reference numeral 703 indicates a graph when the distance r_c between the conducting plates is set to 8 mm, and reference numeral 704 indicates a graph when the distance r_c between the conducting plates is set to 10 mm. In the simulation result of FIG. 7, the conducting plate has a constant thickness. Therefore, when the distance r_c between the conducting plates is reduced, it means that the dielectric distance is reduced. Therefore, through the simulation result of FIG. 7, it can be seen that as the dielectric distance between the conducting plates is reduced, the resonant frequency decreases.

The simulation result of FIG. 7 indicates that as the distance r_c between the conducting plates is reduced, the capacitance value increases. Therefore, miniaturization may be achieved at the same frequency.

Furthermore, through the simulation result of FIG. 7, it can be checked that as the distance is reduced ⅓ times and ⅕ times, the resonant frequency decreases almost 1/\sqrt{3} times and 1/\sqrt{5} times. This means that the reduction of the distance mainly causes the increase of the capacitance value. Here, a slight error may occur because the reduction of the distance causes the decrease of the inductance value.

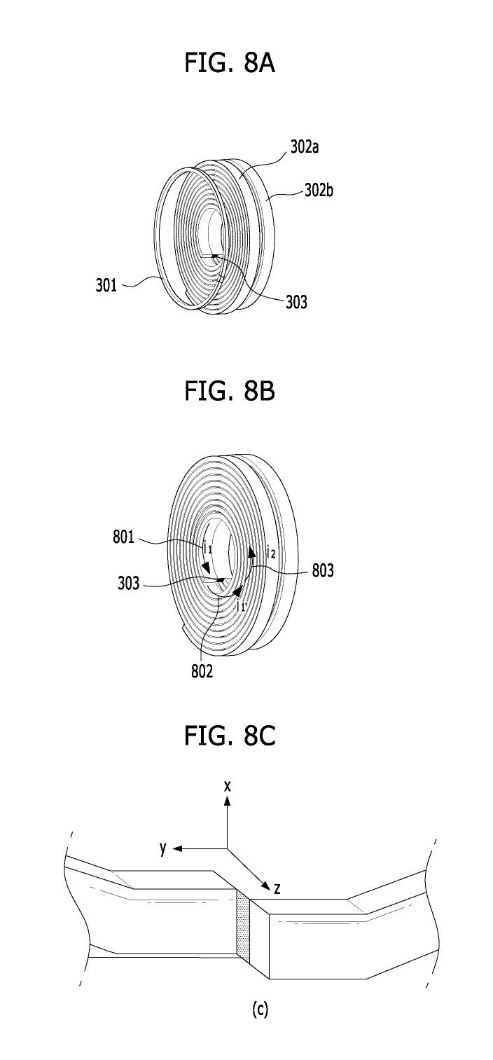

FIGS. 8A to 8C are diagrams explaining a method for connecting a resonant coil having a spiral structure in accordance with the embodiment of the present invention.

FIG. 8A illustrates a resonant coil and a transmitting or receiving coil. In FIG. 8A, when it is assumed that the structure illustrated in FIG. 8A is a transmission-side resonator, the transmission-side resonator has the same shape as shown in FIG. 4. Therefore, the same reference numeral as those of FIG. 4 are used. Different reference numerals 302a and 302b from FIG. 4 are used to discriminate the respective spiral layers.

FIG. 8B illustrates the coupling between the two different spiral layers and the current direction of power induced in the spiral layers, as described with reference to FIG. 4.

As described above, the coils of the two different spiral layers are wound in the opposite directions. In the following descriptions, the spiral layer 302a adjacent to the transmitting coil 301 is referred to as a first spiral layer, and the spiral layer 302b distant from the transmitting coil 301 is referred to as a second spiral layer.

Referring to FIG. 8B, it can be seen that the first spiral layer 302a is wound in the clockwise direction. That is, when it is assumed that the first spiral layer 302a is wound from inside to outside, the coil is wound in the clockwise direction. Furthermore, when it is assumed that the second spiral layer 302b is wound from inside to outside, the second spiral layer 302b is wound in the counterclockwise direction. As such, the two different spiral layers may be wound in the opposite directions. Furthermore, the start point of the first spiral layer 302a and the start point of the second spiral layer 302b are coupled to each other through a conducting plate 303.

The reason that the first and second spiral layers 302a and 302b are wounded in the opposite directions will be described. When the first and second spiral layers 302a and 302b are wound in the opposite directions and coupled to each other, current flows may complement each other, without reducing the number of magnetic force lines by crossing each other. In other words, when the substrates of the first and second spiral layers 302a and 302b are rotated 180 degrees and coupled to each other, the current flows may complement each other, without reducing the number of magnetic force lines.

Such a coupling between the first and second spiral layers 302a and 302b is necessary to increase the overall inductance value and reduce the resonant frequency. A current induced and flowing in the first spiral layer 302a may be represented by i₁. Then, the current induced and flowing in the first spiral layer 302a flows in the coil forming the first spiral layer 302a as indicated by reference numeral 801.

When a current flowing in the conducing plate coupling the first and second spiral layers 302a and 302b is represented by i₁′, the current i₁′ flows along the conducting plate connected from the first spiral layer 302a to the second spiral layer 302b, as indicated by reference numeral 802.

Then, since the second spiral layer 302b and the first spiral layer 302a are wound in the opposite directions, the current passed through the conducting plate 303 from the first spiral layer 302a flows in the same direction, as indicated by i₂.

That is, when the current i₁ in the first spiral layer 302a flows in the counterclockwise direction, the current i₂ flowing in the second spiral layer 302b through the conducting plate 303 flows in the same counterclockwise direction as in the first spiral layer 302a.

At this time, when the first and second spiral layers 302a and 302b are coupled to each other at a position where x-axis and y-axis values are equal to each other, magnetic fields generated by the currents may complement each other. FIG. 8C illustrates that the conducting plate 303 is connected at a position where x-axis and y-axis values are equal to each other.

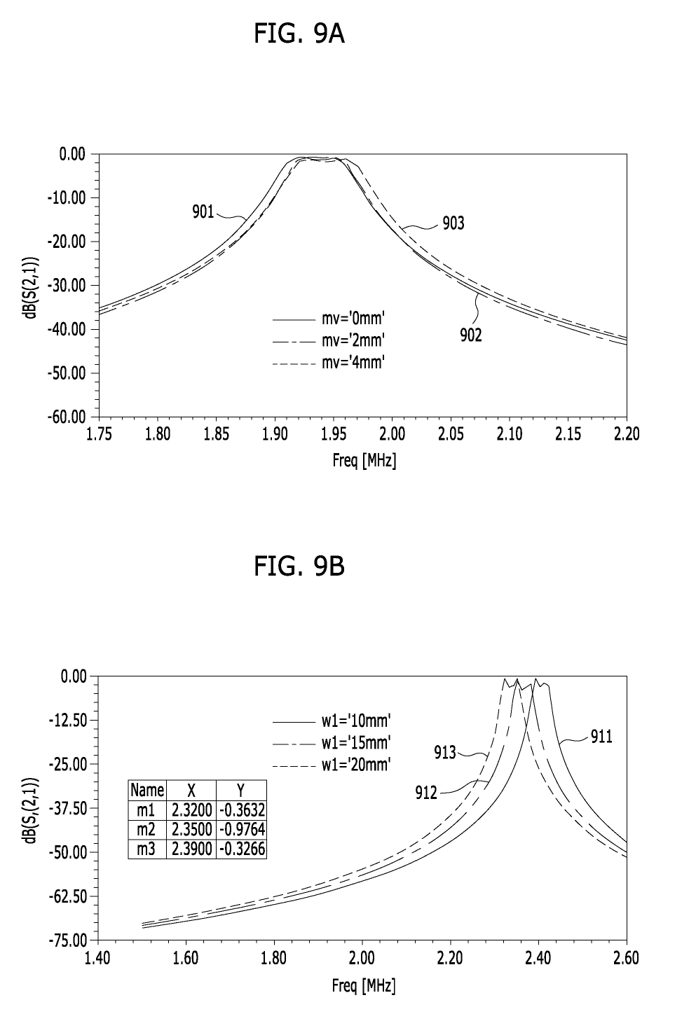

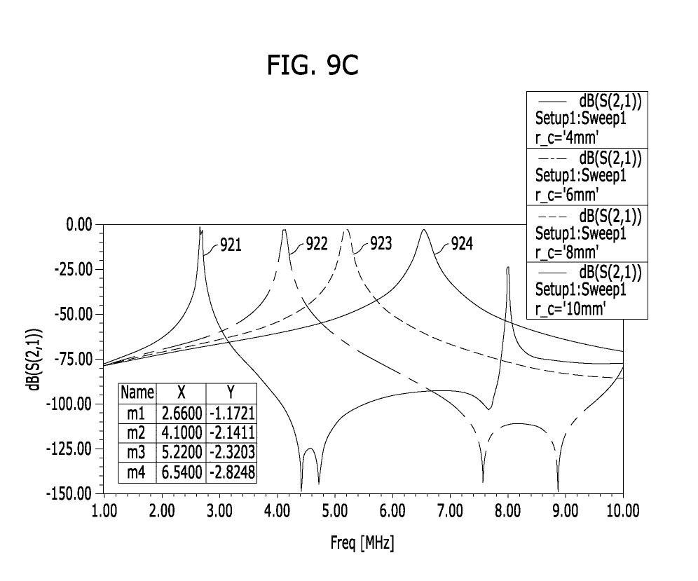

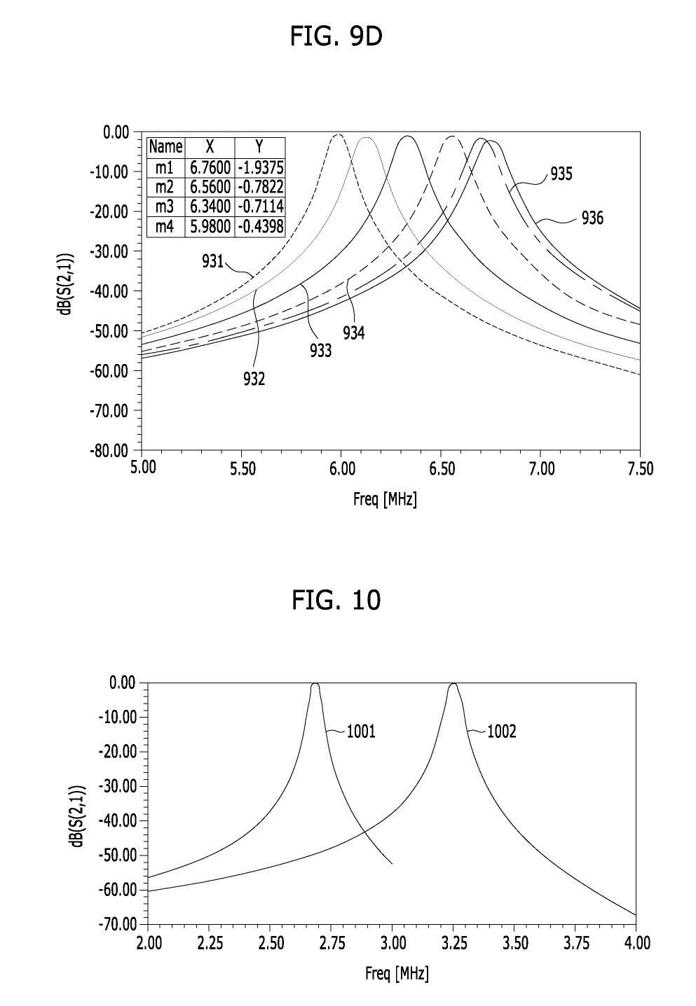

FIGS. 9A to 9D are simulation graphs for explaining a method for tuning the resonant frequency of the resonator manufactured in accordance with the embodiment of the present invention.

FIG. 9A is a simulation graph of a first example for resonant frequency tuning in the resonator in accordance with the embodiment of the present invention.

FIG. 9A shows a simulation result in a case where the first spiral layer 302a is moved in an X-axis or Y-axis direction to tune the resonant frequency when the first and second spiral layers 302a and 302b are arranged.

Referring to the simulation result of FIG. 9A, it can be seen that, when the first spiral layer 302a is moved in the X-axis or Y-axis direction, the resonant frequency is shifted. Reference numeral 901 indicates a case in which the first and second spiral layers 302a and 302b are accurately positioned, that is, a case in which the first and second spiral layers 302a and 302b are not moved in the X-axis or Y-axis direction. Furthermore, reference numeral 902 indicates a case in which the first spiral layer 302a is moved by 2 mm in the X-axis or Y-axis direction, and reference numeral 903 indicates a case in which the first spiral layer 302a is moved by 4 mm in the X-axis or Y-axis direction. Therefore, it can be seen that the first spiral layer 302a in the X-axis or Y-axis direction is moved to tune the resonant frequency.

FIG. 9B is a simulation graph of a second example for resonant frequency tuning in the resonator in accordance with the embodiment of the present invention.

FIG. 9B shows a simulation result when the line width of the conducting plate 303 coupling the first and second spiral layers 302a and 302b is adjusted to tune the resonant frequency.

Reference numeral 911 indicates a resonant frequency when the line width of the conducting plate 303 coupling the first and second spiral layer 302a and 302b is set to 10 mm. Reference numeral 912 indicates a resonant frequency when the line width of the conducting plate 303 coupling the first and second spiral layer 302a and 302b is set to 15 mm. Reference numeral 913 indicates a resonant frequency when the line width of the conducting plate 303 coupling the first and second spiral layer 302a and 302b is set to 20 mm. Referring to FIG. 9B, it can be seen that when the line width of the conducting plate 303 coupling the first and second spiral layers 302a and 302b is adjusted, the resonant frequency is shifted. Therefore, the line width of the conducting plate 303 coupling the first and second spiral layers 302a and 302b may be adjusted to tune the resonant frequency.

FIG. 9C is a simulation graph of a third example for resonant frequency tuning in the resonator in accordance with the embodiment of the present invention.

FIG. 9C shows a simulation result when the distance between the coils forming the first spiral layer 302a or/and the second spiral layers 302b is mechanically reduced. In this case, as the distance between dielectrics inserted between the coils forming the first spiral layer 302a or/and the second spiral layers 302b is mechanically reduced, the distance between the coils forming the spiral layer, that is, the distance r_c between the conducting plates is adjusted to control the capacitance value, thereby tuning the resonant frequency.

Reference numeral 921 indicates a simulation graph of the resonant frequency when the distance between the coils of the first spiral layer 302a or/and the second spiral layers 302b is mechanically reduced to set the distance r_c between the conducting plates to 4 mm. Reference numeral 922 indicates a simulation graph of the resonant frequency when the distance between the coils of the first spiral layer 302a or/and the second spiral layers 302b is mechanically reduced to set the distance r_c between the conducting plates to 6 mm. Reference numeral 923 indicates a simulation graph of the resonant frequency when the distance between the coils of the first spiral layer 302a or/and the second spiral layers 302b is mechanically reduced to set the distance r_c between the conducting plates to 8 mm. Reference numeral 924 indicates a simulation graph of the resonant frequency when the distance between the coils of the first spiral layer 302a or/and the second spiral layers 302b is mechanically reduced to set the distance r_c between the conducting plates to 10 mm. In FIG. 9C, symbols m1, m2, m3, and m4 represent mark values in the graph. That is, symbols m1, m2, m3, and m4 indicate a frequency at which resonance occurs and what is an insertion loss S21 at the frequency. In the simulation of FIG. 9C, the distance between the dielectric materials in the two spiral layers 302a and 302b is adjusted.

FIG. 9D is a simulation graph of a fourth example for resonant frequency tuning in the resonator in accordance with the embodiment of the present invention.

FIG. 9D shows a simulation result when the resonant frequency is varied by serially inserting a lumped capacitor element into a spiral layer forming the resonant body. As known from the simulation result of FIG. 9D, the lumped capacitor element may be connected in series to vary the resonant frequency. Tuning the resonant frequency as shown in FIG. 9D is necessary to mass-produce real products, and an operation of matching the resonant frequencies of transmission/reception resonant bodies is inevitably required. Therefore, this is the easiest way to vary the resonant frequency.

Reference numeral 931 indicates a simulation result graph showing changes in resonant frequency when the capacity of the lumped capacitor is 10 pF. Reference numeral 932 indicates a simulation result graph showing changes in resonant frequency when the capacity of the lumped capacitor is 30 pF. Reference numeral 933 indicates a simulation result graph showing changes in resonant frequency when the capacity of the lumped capacitor is 100 pF. Reference numeral 934 indicates a simulation result graph showing changes in resonant frequency when the capacity of the lumped capacitor is 316.227766 pF. Reference numeral 935 indicates a simulation result graph showing changes in resonant frequency when the capacity of the lumped capacitor is 1000 pF. Reference numeral 936 indicates a capacitor value ranging from 10 uF to 1000 uF. As known from the result, when the capacitor value c1 ranges from 10 uF to 1000 uF, the same result is acquired, which means that when the capacitor value c1 is equal to or more than 10 uF, the resonant frequency is not tuned any more.

FIG. 10 shows simulation results based on changes in resonant frequency when a dielectric material is inserted into the entire resonant body and when a part of the dielectric material is removed.

In FIG. 10, reference numeral 1001 indicates a simulation result graph of the resonant frequency when the dielectric material is inserted between the conducting plates forming the spiral coil and between the spiral layers, and reference numeral 1002 indicates a simulation result graph of the resonant frequency when a part of the dielectric material between the conducting plates forming the spiral coil and/or the between the spiral layers is removed.

As known from the simulation result of FIG. 10, the insertion of the dielectric material may lower the resonant frequency, thereby contributing to miniaturization. At this time, the most important factor is a tan loss of the dielectric material, and a material of which the tan loss is as small as possible may be selected as the dielectric material. In general, a dielectric material may be represented by a relative permittivity and a dielectric loss factor. For example, the dielectric material may be expressed in a complex number form of “3+j0.01”. Here, 0.01 of j term in the complex number form serves as a loss. This is because a j term in the Maxwell's equation serves as a loss. That is, the tan loss indicates a j term value. Furthermore, the dielectric material may be maintained to about 0.001 or less. This indicates that the resonant frequency changes according to the dielectric value between the conducting plates or the thickness of the dielectric material.

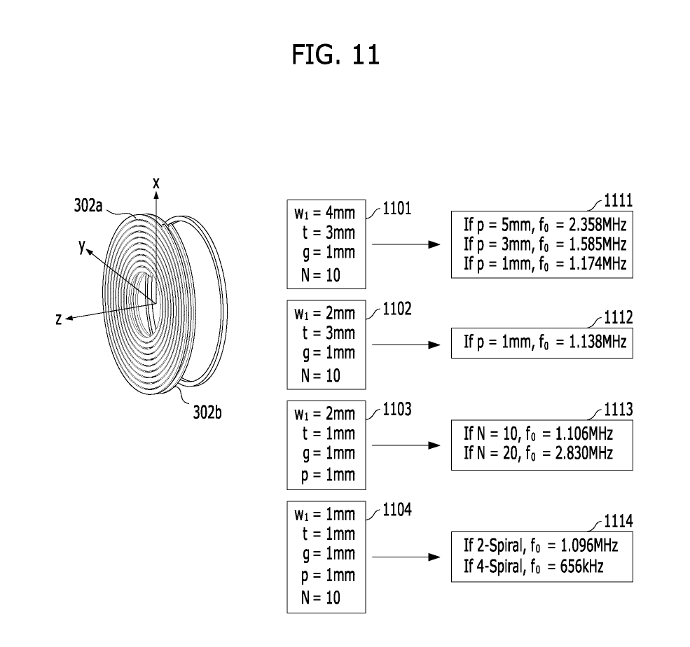

FIG. 11 is a diagram for explaining changes in resonant frequency while the structure of the resonant body is modified in various manners.

FIG. 11 shows that the resonant frequency is varied when two spiral structures are coupled and the line width w₁ of the spiral layers, a distance p between the spiral layers, and a turn number N are changed. The following simulation results will be described in a state in which the diameter of the spiral layers is assumed to be 15 cm.

Reference numeral 1101 represents a condition where the line width w₁ is 4 mm, a line thickness t is 3 mm, a dielectric thickness g is 1 mm, and the turn number N is 10. At this time, the resonant frequency is changed according to changes in the distance p between the spiral layers, as indicated by reference numeral 1111. That is, when two different spiral layers are provided and the distance p between the first and second spiral layers 302a and 302b is 5 mm, the resonant frequency f₀ is 2.358 MHz. Furthermore, when the distance p between the first and second spiral layers 302a and 302b is 3 mm, the resonant frequency f₀ is 1.585 MHz, and when the distance p between the first and second spiral layers 302a and 302b is 1 mm, the resonant frequency f₀ is 1.174 MHz. Through the simulation result, it can be seen that as the distance p between the first and second spiral layers 302a and 302b is reduced, the resonant frequency f₀ decreases.

Reference numeral 1102 represents a condition when only the line width w₁ is reduced under the condition 1101. That is, when only the line w₁ is reduced to 2 mm and the distance p between the first and second spiral layers 302a and 302b is set to 1 mm under the same condition as the condition 1101, the resonant frequency f₀ becomes 1.138 MHz. Through the simulation result, it can be seen that as the line width is reduced, the resonant frequency decreases.

Through the above-described two conditions, it can be seen that when the two spiral structures are coupled in such a manner that the line width w₁ is reduced and the distance p between the spiral layers is set to a small value of 1 mm, the resonant frequency f₀ decreases. When the line width w₁ and the distance p between the spiral layers are reduced to increase the inductance value in a state in which the capacitance value is sufficiently increased as described above, the inductance value may be sufficiently increased while the increased capacitance value is maintained.

Reference numeral 1103 represents a condition in which the line width w₁ is 2 mm, the line thickness t is 1 mm, the dielectric thickness g is 1 mm, and the distance between the spiral layers is 1 mm. Under such a condition, the turn number N is varied as indicated by reference numeral 1113. First, when the turn number N is 10, the resonant frequency f₀ is 1.106 MHz. When the turn number N is 20, the resonant frequency f₀ is 2.830 MHz. Through the simulation result, it can be seen that when the turn number N increases to a predetermined number or more, the capacitance value is reduced while the inductance value increases, and thus the resonant frequency f₀ increases again.

Next, a case in which a larger number of spiral layers are provided will be described.

Reference numeral 1104 represents a condition in which the line width w₁ is 1 mm, the line thickness t is 1 mm, the dielectric distance g is 1 mm, the distance p between the spiral layers is 1 mm, and the turn number N is 10. This condition corresponds to the most optimal state among the above-described conditions.

Reference numeral 1114 indicates a simulation result of changes in resonant frequency f₀ when two spiral layers are provided and when four spiral layers are provided. When the two spiral layers are provided as shown in FIG. 11, the resonant frequency f₀ becomes 1.096 MHz. However, when the four spiral layers are provided, the resonant frequency f₀ decreases to 656 kHz.

Now, a method for connecting four spiral layers will be described briefly.

When four spiral layers are provided, the connection of the respective spiral layers may be performed by expanding the structure in which the two spiral layers are provided. First, the case in which the two spiral layers are provided will be described.

As described above, one spiral layer is constructed by winding a coil having a constant thickness and line width by a predetermined number. Then, two spiral layers are coupled in such a manner that the winding directions of the coils in the respective spiral layers are set in the opposite directions. Furthermore, the internal start points of the respective spiral layers are coupled to each other through a conducting plate. This has been already described with reference to FIGS. 4, 5, and 8A to 8C.

When another spiral layer is constructed, the spiral layer is wounded in the opposite direction of a spiral layer coupled over or under the spiral layer. That is, a coil forming the spiral layer may be wound in the opposite direction of the winding direction of a coil forming a spiral layer which is directly contacted with the spiral layer. Then, external lines of the coils forming the spiral layers are coupled. When the spiral layers are coupled in such a manner, the current is passed in the same direction as described above with reference to FIGS. 8A to 8C. Therefore, the current direction is not hindered.

When another spiral layer is to be coupled after the three spiral layers are constructed, a coil of the spiral layer is wound in the opposite direction of the winding direction of a coil forming a spiral layer coupled over or under the spiral layer, that is, a spiral layer which is directly contacted with the spiral layer. Then, when the spiral layer contacted with the newly-constructed spiral layer is contacted with another spiral layer such that the internal portions of the coils are coupled to each other, that is, when the internal portions are coupled as described with reference to FIGS. 4, 5, and 8A to 8C, external portions of the coils are coupled through a conducting plate. On the other hand, when the spiral layer contacted with the newly-constructed spiral layer is contacted with another spiral layer such that external portions of the coils coupled to each other, the internal portions may be coupled to each other through a conducting plate as described with reference to FIGS. 4, 5, and 8A to 8C.

When the spiral layers are coupled in such a manner, the current flows may be maintained as described above, which makes it possible to increase the efficiency of an induced electromotive force.

When one spiral layer having a line width of 10 mm is provided, the resonant frequency is 7.1 MHz, and when two spiral layers having a line width of 4 mm are provided, the resonant frequency is 1.174 MHz. Therefore, when two or more spiral layers are provided, it is possible to reduce the resonant frequency. Furthermore, as known from the simulation result of FIG. 11, when the line width is reduced and the distance between the spiral layers is sufficiently reduced to 1 mm or less, the resonant frequency may be more effectively reduced, thereby contributing to miniaturization.

When the four spiral layers are connected in such a manner as to have a final diameter of 15 cm and a thickness of 1 cm, resonance may occur at 656 kHz. At this time, the line width w₁, the distance p between the spiral layers, the line thickness t, and the thickness g of the dielectric material are all 1 mm, and the turn number N is 10.

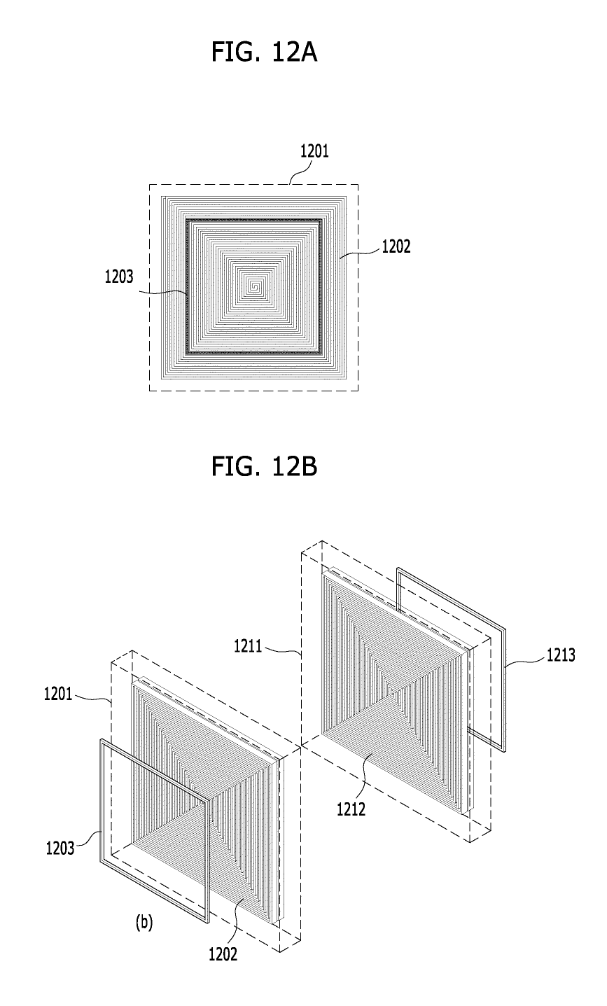

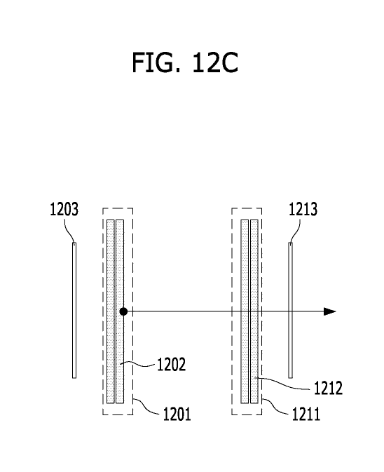

FIGS. 12A to 12C illustrate the structure of a resonator having two rectangular spiral layers in accordance with another embodiment of the present invention.

FIG. 12A is a top view of a transmission-side resonant body or reception-side resonant body having a rectangular structure. That is, reference numeral 1202 represents a coil having a predetermined line width and line thickness, and reference numeral 1203 represents a feeding loop. The feeding loop 1203 also has a rectangular structure, like the resonant body. Reference numeral 1201 represents an external boundary shape of the transmission-side resonant body or reception-side resonant body, and indicates a case in which a dielectric material having a predetermined permittivity completely covers the resonant coil. At this time, a dielectric material having a permittivity εᵣ of 10 may be used. However, a difference between when the dielectric material is inserted and when the dielectric material is not inserted lies only in a relation of f₀/\sqrt{εᵣ} in the resonant frequency. That is, the dielectric layer may be inserted or may not be inserted. In other words, reference numeral 1201 may be included or may not be included.

The coil forming the transmission-side resonant body or reception-side resonant body having a rectangular shape as described with reference to FIG. 12A has a constant line width and line thickness as described above, and is constructed in a rectangular shape. Therefore, the resonant body may include two or more layers. When two or more layers are provided, the layers may be coupled in the same manner as described above. Furthermore, the resonant body has no empty space inside, different from the circular resonant body. This may be checked with reference to FIG. 4.

FIG. 12B is a perspective view of primary and secondary resonant bodies which are arranged to wirelessly transfer power in accordance with the embodiment of the present invention. Referring to FIG. 12B, the transmission-side resonant body and the reception-side resonant body are spaced a predetermined distance from each other to wirelessly transfer power. The transmission-side resonant body includes a feeding loop 1203 positioned in the opposite side of a receiving loop 1213 included in the reception-side resonant body. As described above, the transmission-side resonant body 1202 includes an external boundary 1201 for maintaining the rectangular structure.

The reception-side resonant body 1212 having a rectangular shape is disposed at a position facing the transmission-side resonant body. As described above, the receiving loop 1213 of the reception-side resonant body 1212 is positioned in the opposite side of the feeding loop 1203 of the transmission-side resonant body 1202.

FIG. 12C is a side view of FIG. 12B. That is, FIG. 12C illustrates the resonant bodies 1202 and 1212 when seen from a side of FIG. 12B. In FIG. 12C, the same reference numerals as those of FIG. 12B are used for convenience of description, and thus the detailed descriptions thereof are omitted herein.

The resonant bodies having a rectangular shape, which have been described with reference to FIGS. 12A to 12C, have the same characteristic as the resonant body having a circular spiral structure. However, the rectangular spiral structure illustrated in FIGS. 12A to 12C may cause an increase of inductance within the same area, compared with the circular spiral structure. When the length of one side of the rectangular structure is set 15 cm which is equal to the diameter of FIG. 11, the line width and the distance between the spiral layers are set to the same values, and two rectangular spiral layers are provided, the resonant frequency decreases to 576 KHz. Furthermore, when four rectangular spiral layers are provided, the resonant frequency decreases to 356 KHz. Furthermore, when eight rectangular spiral layers are provided, the resonant frequency decreases to 255 KHz.

While the present invention has been described with respect to the specific embodiments, it will be apparent to those skilled in the art that various changes and modifications may be made without departing from the spirit and scope of the invention as defined in the following claims.

What is claimed is:

1. A wireless power transfer apparatus comprising:
a transmitting coil into which a current having a predetermined frequency is introduced;
a receiving coil configured to supply a current induced by electromagnetic induction to a load; and
a transmission-side resonant coil and a reception-side resonant coil positioned between the transmitting coil and the receiving coil, configured to provide the current flowing in the transmitting coil to the receiving coil through electromagnetic induction, and spaced a predetermined distance from each other,
wherein each of the resonant coils has a spiral structure.

2. The wireless power transfer apparatus of claim 1, wherein the resonant coil comprises a conducting plate having a predetermined line width and line thickness, and is constructed in a circular spiral structure.

3. The wireless power transfer apparatus of claim 1, wherein the resonant coil comprises a conducting plate having a predetermined line width and line thickness, and is constructed in a rectangular spiral structure.

4. The wireless power transfer apparatus of claim 2, further comprising a predetermined dielectric material inserted between the conducting plates having a spiral structure.

5. The wireless power transfer apparatus of claim 2, wherein the resonant coil is constructed by stacking two or more spiral layers in a helical shape and coupling the spiral layers.

6. The wireless power transfer apparatus of claim 5, wherein the resonant coil comprises a predetermined dielectric material inserted between the two or more spiral layers.

7. The wireless power transfer apparatus of claim 5, wherein each of the two or more spiral layers is rotated (wound) in the opposite direction of the rotation direction (winding direction) of another spiral layer which is directly contacted.

8. The wireless power transfer apparatus of claim 7, wherein the two or more spiral layers are coupled in such a manner that when the induced currents are passed in the respective spiral layers, the currents flow in the same direction.

9. A method for manufacturing a resonant coil forming a wireless power transfer apparatus, comprising:
winding a conducting plate having a predetermined line width and line thickness in a spiral shape;
stacking two or more spiral layers in a helical shape such that each of the spiral layers is wound in the opposite direction of the winding direction of another spiral layer which is directly contacted; and
coupling the respective spiral layers through a conducting plate such that magnetic fields generated by the currents induced between the spiral layers complement each other.

10. The method of claim 9, wherein the spiral shape comprises a rectangular shape.

11. The method of claim 9, wherein the spiral shape comprises a circular shape.

12. The method of claim 10, wherein a predetermined dielectric material is inserted between the conducting plates forming the spiral layers.

13. The method of claim 10, wherein a predetermined dielectric material is inserted between the spiral layers.

14. A method for tuning a resonant frequency in a resonant coil forming a wireless power transfer apparatus, the method comprising:
a plurality of spiral layers constructed by winding conducting plates having a predetermined line width and line thickness in a spiral shape and stacked in a helical shape such that the winding direction of each of the spiral layers is set in the opposite direction of the winding direction of another spiral layer which is directly contacted; and
a conducting plate coupling the spiral layers such that magnetic fields generated by currents induced between the spiral layers complement each other.

15. The method of claim 14, wherein at least one of the spiral layers is moved by a distance corresponding to a predetermined resonant frequency in a one-axis direction.

16. The method of claim 14, wherein the conducting plate has a line width corresponding to a predetermined resonant frequency.

17. The method of claim 14, wherein a predetermined dielectric material is inserted between the spiral layers and between the conducting plates forming the spiral layers, and
a distance between the conducting plates which form the spiral layers and between which the dielectric material is inserted is controlled to a distance corresponding to a predetermined resonant frequency.

18. The method of claim 14, wherein one of the spiral layers is coupled to a capacitor having a value corresponding to a predetermined resonant frequency.
